(19) United States
(12) Patent Application Publication
(10) Pub. No.: US 2026/0116235 A1
(43) Pub. Date: Apr. 30, 2026

(54) EXTERNALLY DISPLAYING VEHICLE BATTERY CHARGE STATUS USING ONBOARD VEHICLE DISPLAY TECHNOLOGY

(71) Applicant: Volvo Car Corporation, Göteborg (SE)

(72) Inventors: Hossein Soleimani, Gothenburg (SE); Bhavesh Patel, Gothenburg (SE); Balaji Vadivel, Gothenburg (SE); Divya Ravikumar, Gothenburg (SE); Ping Gong, Gothenburg (SE)

(21) Appl. No.: 18/926,498

(22) Filed: Oct. 25, 2024

(51) Int. Cl. B60L 53/62; B60K 35/10; B60K 35/233; B60K 35/28; B60K 35/81; B60L 53/66; B60L 53/68; B60Q 1/50

(52) U.S. Cl. CPC B60L 53/62; B60K 35/10; B60K 35/233; B60K 35/28; B60K 35/81; B60L 53/66; B60L 53/68; B60Q 1/544; B60K 2360/169; B60K 2360/188; B60K 2360/55; B60K 2360/592; B60L 2250/16

(57) ABSTRACT

Techniques for externally displaying electric vehicle (EV) battery charge status using onboard vehicle display technologies are provided. For example, a method comprises determining, by a system onboard a vehicle comprising a processor, charge status information regarding a state of charge of a battery system of the vehicle that supplies power to a propulsion system of the vehicle, and controlling, by the system, displaying a visual signal of the charge status information using one or more electronic devices integrated on or within the vehicle, the visual signal being visible from a position outside the vehicle. For example, the one or more electronic device can include one or more lights onboard the vehicle and/or an electronic display apparatus onboard the vehicle.

### TECHNICAL FIELD

The disclosed subject matter relates to electric vehicles (EVs), and more particularly, to techniques for externally displaying vehicle battery charge status using onboard vehicle display technology.

### BACKGROUND

An electric vehicle (EV) is a type of vehicle that utilizes one or more electric motors for propulsion, instead of a traditional internal combustion engine (ICE) that runs on gasoline or diesel. EVs are powered by rechargeable batteries, which store electricity and provide energy to the electric motor(s) to drive the vehicle. Electric vehicles (EVs) are charged by connecting them to an external charging apparatus (generally referred to as a charging station), typically through a charging cable. EV charging stations typically display charging status using display screens coupled to the charging stations to provide users with status information about the progress of their charging session. The problem, however, is that the users must physically walk up to the EV charging station each time they would like to view the status information.

The above-described background relating EV charging session monitoring is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate techniques for externally displaying vehicle battery charge status using onboard vehicle display technology.

As alluded to above, techniques displaying EV charging status without requiring the user to walk up the charging station are desirable, and various embodiments are described herein to this end and/or other ends.

According to an embodiment, a vehicle can comprise a memory that stores computer executable components and a processor that executes the computer executable components stored in the memory, wherein the computer executable components comprise a charge status component that determines charge status information regarding a state of charge (SoC) of a battery system of the vehicle that supplies power to a propulsion system of the vehicle, and a charge display component that controls displaying a visual signal of the charge status information using one or more electronic devices integrated on or within the vehicle, the visual signal being visible from a position outside the vehicle.

In some embodiments, the charge display component generates the visual signal using an electronic display apparatus of the vehicle that projects the visual signal onto one or more windows of the vehicle. In other embodiments, the charge display component generates the visual signal using an electronic display apparatus of the vehicle that projects the visual signal onto an area of ground external to the vehicle. Still in other embodiments, the charge display component generates the visual signal using one or more lights of the vehicle, such as one or more exterior lights of the vehicle (e.g., headlights, taillights, break lights, etc.).

In some implementations, the charge display component can generate the visual signal without connection of the vehicle to a charging apparatus. With these implementations, the charge status information can indicate the current SoC of the vehicle. In other implementations, the charge display component can generate the visual signal in association with connection of the vehicle to a charging apparatus. With these implementations, the charge status information can indicate information about the current SoC and the charging session, such as the amount of time remaining until the battery system reaches its fully charged capacity and the like.

In another embodiment, a method comprises, determining, by a system onboard a vehicle comprising a processor, charge status information regarding a SoC of a battery system of the vehicle that supplies power to a propulsion system of the vehicle, and controlling, by the system, displaying a visual signal of the charge status information using one or more electronic devices integrated on or within the vehicle, the visual signal being visible from a position outside the vehicle. In some embodiments, the controlling comprises generating, by the system, the visual signal using an electronic display apparatus of the vehicle that projects the visual signal onto one or more windows of the vehicle and/or an area of ground external to the vehicle. In other embodiments, the controlling comprises generating, by the system, the visual signal using one or more lights of the vehicle.

In another embodiment, a non-transitory machine-readable storage medium, comprising executable instructions that, when executed by a processor onboard a vehicle, facilitate performance of operations, comprising determining charge status information regarding a state of charge of a battery system of the vehicle that supplies power to a propulsion system of the vehicle, and controlling displaying a visual signal of the charge status information using one or more electronic devices integrated on or within the vehicle, the visual signal being visible from a position outside the vehicle. In this regard, the controlling comprises at least one of, generating the visual signal using an electronic display apparatus of the vehicle, or generating the visual signal using one or more lights of the vehicle.

### BRIEF DESCRIPTION OF DRAWINGS

FIG. 1 illustrates a block diagram of an exemplary system that facilitates externally displaying vehicle battery charge status using onboard vehicle display technology, in accordance with one or more embodiments described herein.

FIG. 2 illustrates an implementation of an example method for externally displaying vehicle charge status information in accordance with one or more embodiments described herein.

FIG. 3 illustrates an implementation of another example method for externally displaying vehicle charge status information in accordance with one or more embodiments described herein.

FIG. 4 illustrates a block flow diagram of an example, non-limiting computer-implemented method for externally displaying vehicle charge status information in accordance with one or more embodiments described herein.

FIG. 5 illustrates a block flow diagram of another example, non-limiting computer-implemented method for externally displaying vehicle charge status information in accordance with one or more embodiments described herein.

FIG. 6 illustrates a block flow diagram of another example, non-limiting computer-implemented method for externally displaying vehicle charge status information in accordance with one or more embodiments described herein.

FIG. 7 is an example, non-limiting computing environment in which one or more embodiments described herein can be implemented.

FIG. 8 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, techniques for externally displaying an EV's battery system charge information by the EV are desirable. The proposed techniques can use various visual indicators of the existing EV to display the status of charging or discharging and other information about a charging session and SoC of the EV in a manner that can be seen from a distance outside the vehicle.

In various embodiments, the disclosed subject matter provides techniques for externally displaying, by an EV, a visual signal regarding the charge status of the EV in association with connection of the EV to a charging station. For example, in an aspect, when EV is connected to the charging station for charging or discharging, the EV's onboard computer system receives the charging status information from the charging station or otherwise determines the charging status information. In some implementations, using a light projection display apparatus located on or within the EV, the EV can project the charge status information (as controlled by the onboard computer system) onto one or more windows of the EV (e.g., the front windshield, the rear windshield, and/or one or more side windows). In other implementations, the light projection display apparatus can project the charge status information onto an area of ground external to the vehicle. In other implementations, the EV can generate a visual signal of the charge status information using one or more lights of the EV. For example, using one or more external lights of the vehicle (e.g., headlights, taillights, break lights, turn signal lights, hazard lights, fog lights, reverse lights, daytime running lights, etc.), the onboard computer system can control the lights to generate different light patterns, pulsed/flashing light sequences and/or colors, corresponding to different signals indicative of different aspects of the charge status information such as signals corresponding to charging, discharging, not charging, fully charged, charging faults, and so on.

In other embodiments, the disclosed techniques can provide for externally displaying information regarding the SoC of the EV in scenarios in which the vehicle is not connected to a charging station, such as when the vehicle is parked. For instance, prior to using an EV, a user may desire to know its current SoC without having to walk close to and/or enter the vehicle. Thus in some embodiments, the EV can generate the external visual signal of the SoC of the vehicle using one or more of the techniques describe above when the vehicle is parked and/or in response to a trigger signal, such as a request signal provided by an external device (e.g., a corresponding button on the vehicle's key fob or the like), and/or another type of trigger signal.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

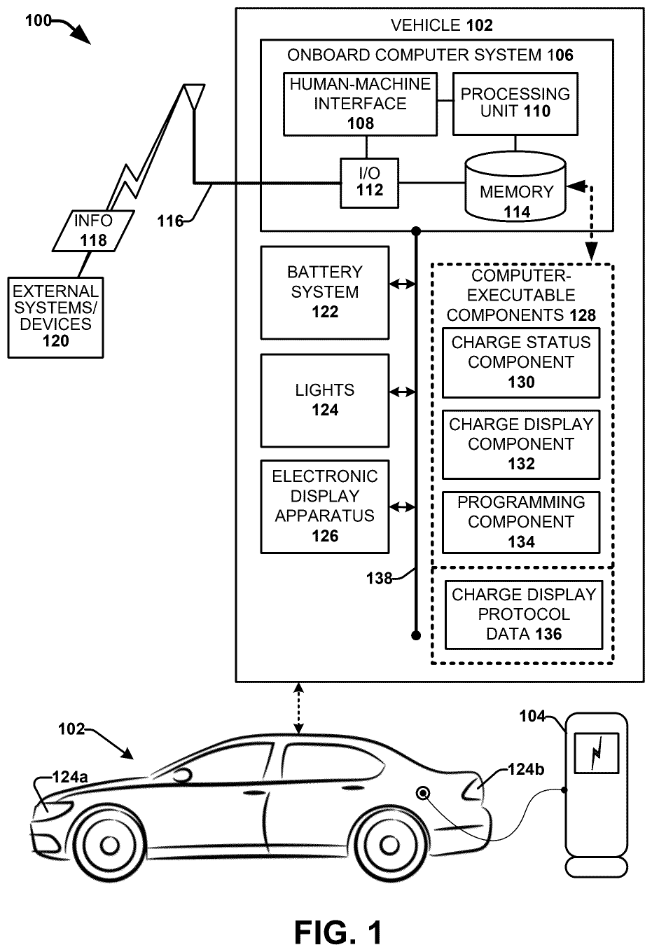

Turning now to the drawings, FIG. 1 illustrates a block diagram of an exemplary system 100 that facilitates externally displaying vehicle battery charge status using onboard vehicle display technology, in accordance with one or more embodiments described herein. System 100 comprises a vehicle 102 that includes a battery system 122, lights 124 and an electronic display apparatus 126. In various embodiments vehicle 102 include or corresponds to an EV and the battery system 122 corresponds to a rechargeable battery system comprising one or more rechargeable batteries that supply power to one or more electric motors of the vehicle 102 for propulsion and/or other electrical systems/devices of the vehicle 102. The battery system 122 can be recharged by connecting the battery system 122 to an external charging apparatus 104 (generally referred to as a charging station) via a charging cable, as shown in FIG. 1.

The lights 124 of the vehicle can correspond to various lights located on and/or within vehicle 102. In various embodiments, the lights 124 can include various external lights of the vehicle 102, such as but not limited to, headlights (e.g., headlights 124a), taillights (e.g., taillights 124b), break lights, turn signal lights, hazard lights, fog lights, reverse lights, daytime running lights, and other types of external lights that emit light external to the vehicle 102. To this end, the lights 124 can include the various conventional or standard external lights that are included with existing cars. Additionally, or alternatively, the lights 124 can include one or more specialty lights that are added to the vehicle for the purpose of generating visual light signals indicating the SoC of the battery system 122 and charging/discharging status information of the battery system 122 in association connection of the battery system 124 to the external charging apparatus 104. For example, such specialty lights can include one or more dedicated lights positioned on or within the vehicle 102 that are configured to emit visual light signals that can be seen from a position external to the vehicle. The light signals can include variations in light intensity, color, pulsation patterns and/or sequences, and the like.

The electronic display apparatus 126 can include or correspond to any type of electronic display device integrated on or within the vehicle 102 and configured to generate one or more visual signals that can be seen from a position external to the vehicle 102. As used herein, an electronic display apparatus refers to a device used to present visual information electronically, including text, images, videos, and other multimedia content. For example, in some embodiments, the electronic display apparatus 126 can include or correspond to one or more light projection devices (or more generally a light projector) configured to project and display one or more visual signals (e.g., images, patterns, text, etc.) onto one or more windows of the vehicle 102 (e.g., the front windshield, the back windshield, the side windows, and the like). With these embodiments, the light projection device can employ any suitable projection technology to produce projected visual signals on the internal and/or external surfaces of the one or more windows of the vehicle 102. In another embodiment, the electronic display apparatus 126 can include or correspond to one or more display panels, such as but not limited to, a liquid crystal display (LCD) panel, a light emitting diode (LED) panel, and the like. With these embodiments, the one or more display panels can be located at one or more positions inside the vehicle 102 that can be seen from a position outside the vehicle, and/or mounted to the external surface of the vehicle (e.g., mounted on the roof or another position).

Vehicle 102 further includes an onboard computer system 106 that is communicatively and operatively connected to the battery system 122, the lights 124, the electronic display apparatus 126, and/or various other electronic systems/devices of the vehicle 102 via a system bus 138 and/or any suitable wireless or wired communication/connection technology. The onboard computer system 106 can also connect to various external systems/device 120 using any suitable wired or wireless communication technology. For example, the onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or system configured to wirelessly communicate (e.g., using radio frequency signals) with the onboard computer system 106, such as but not limited to, a mobile device associated with one or more users of the vehicle 102 (e.g., a smartphone, a smartwatch, a tablet, or another type of wearable device), a key vehicle key fob, a charging station (e.g., charging apparatus 104), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

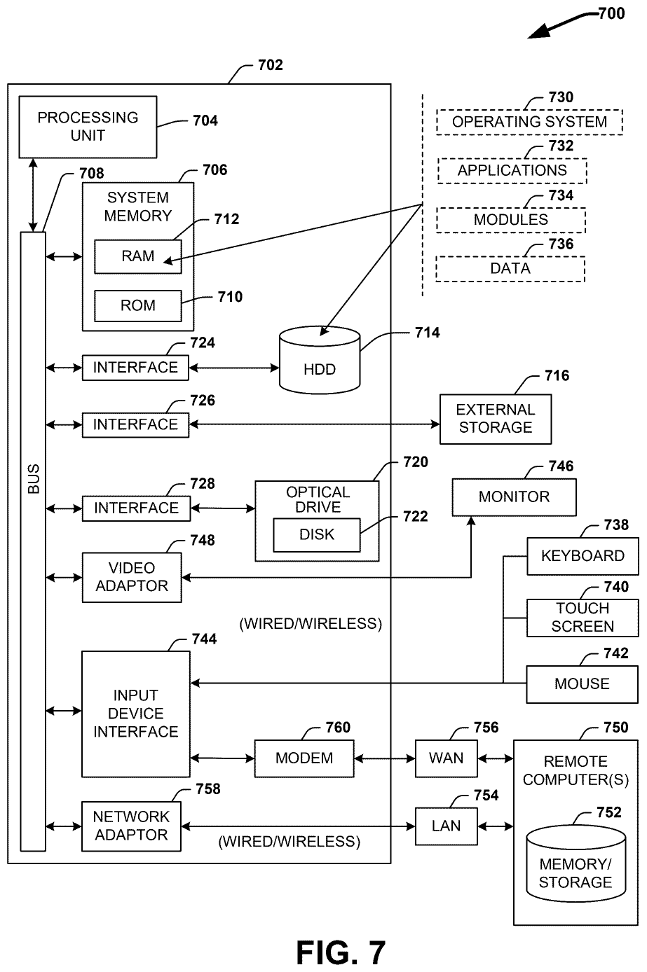

The onboard computer system 106 further includes a memory 114 that stores computer-executable components 128 that facilitate facilitates externally displaying vehicle battery charge status using onboard vehicle display technology (e.g., using the one or more lights 124 and/or the electronic display apparatus 126). These computer-executable components can include charge status component 130, charge display component 132 and programming component 134. The onboard computer system 106 includes at least one processor or processing unit 110 that executes the computer-executable component 134 stored in memory 114 to carry out the operations/functions described with respect to the corresponding computer-executable components. Examples of said memory 114, processing units 110, and other computer system components that can be included in the onboard computer system 106 to facilitate the various features and functionalities of system 100 can be found with reference to FIG. 7 (e.g., system memory 710, processing unit 704, and the like).

Generally, the charge status component 130 determines charge status information regarding a SoC of the battery system 122 of the vehicle 102. In various embodiments, the charge status component 130 determines (or otherwise obtains) charge status information in association with connection of the battery system 122 to an external charging apparatus 104. With these embodiments, the charge status information can include but is not limited to, the current charging status of the battery system 122 (e.g., charging in progress, discharging, or not charging), the current SoC of the battery system 122, the duration of time remaining until the battery system 122 reaches its maximum charge capacity, the current charging speed or rate, and any potential errors or faults related to the charging session and/or the external charging apparatus 104.

The mechanism or mechanisms via which the charge status component 130 determines such charge status information in association with connection of the battery system 122 to the external charging apparatus 104 can vary. For example, in some implementations, the charge status component 130 can determine the current SoC of the battery system 122 directly (e.g., based on connecting to the battery system 122 via system bus 138 and/or wirelessly). The charge status component 130 can similarly determine whether the battery system 122 is in a state of charging, discharging, or not charging by directly interfacing with the battery system 122. The charge status component 130 can also directly determine the rate of charging by monitoring the rate or speed at which the battery system's charge level increases over a sampled period of time during the charging session. The charge status component 130 can also directly determine the estimated duration of time until the battery system 122 reaches its full capacity based on the rate of charge, the current SoC of the battery system 122 and the maximum charge capacity of the battery system 122.

Additionally, or alternatively, the charge status component 130 can receive information regarding the charging session from the external charging apparatus 104. For example, in some embodiments, the onboard computer system 106 can be communicatively coupled to the external charging apparatus 104 via any suitable wired or wireless communication technology. With these embodiments, the external charging apparatus 104 can be configured to provide (e.g., send, transmit, etc.) some or all of the charge status information described above to the charge status component 130. The external charging apparatus 104 can also provide the charge status component 130 with notification information regarding any faults or errors detected by the external charging apparatus 104 in association with connection of the battery system 122 thereto.

In accordance with some embodiments in which the battery system 122 is connected to an external charging apparatus 104, the charge status component 130 can be configured to determine or receive the charge status information in response to initial connection of the battery system 122 to the external charging apparatus 104. The charge status component 130 can further be configured to regularly (e.g., according to a defined update rate) and/or continuously update the charge status information over the course of the charging session until the battery system 122 reaches full capacity and/or the charging session is otherwise ended (and the battery system is disconnected from the external charging apparatus 104.

The charge display component 132 controls displaying a visual signal of the charge status information using one or more electronic devices integrated on or within the vehicle 102, the visual signal being visible from a position outside the vehicle. In this regard, the one or more electronic devices can include but are not limited to, one or more of the lights 124 and/or the electronic display apparatus 126.

In some embodiments, the charge display component 132 can control one or more lights 124 of the vehicle 102 to cause them to generate one or more visual signals that indicate one or more aspects of the charge status information (e.g., charging/discharging state, charging rate, current SoC, errors/faults, etc.). In other words, the charge display component 130 can use different light signals to indicate different types of charge status information, such as a first light signal to indicate the system 122 is in a state of charge, a second light signal to indicate the battery system 122 is in a state of discharging, a third light signal to indicate the battery system 122 is not being charged, a fourth light signal to indicate the SoC of the battery system 122 is less low (e.g., less than a first defined threshold SoC), a fifth light signal to indicate the SoC of the battery system 122 is medium (e.g., between the first defined SoC and a second defined SoC), a sixth light signal to indicate the SoC of the battery system is high, and so on. With these embodiments, the different visual signals can be based on turning on and off one or more lights, turning on and/or off different lights, generating different pulsed (or flashing/blinking) light patterns or sequences using one or more of the lights, and/or changing the color and/or intensity of the light emitted by one or more of the lights 124. With these embodiments, information defining different light signals (e.g., using one or more of the lights 124) corresponding to different types of charge status information can be defined in memory 114 and is represented in system 100 as charge display protocol data 136. The charge display protocol data 136 can also define and control what types of charge status information light signals to display when and the rate displaying updated charge status information in association with connection of the vehicle 102 to the external charging apparatus 104. The charge display component 132 can further control the lights 124 to generate the corresponding light signals in accordance with the charge display protocol data 136.

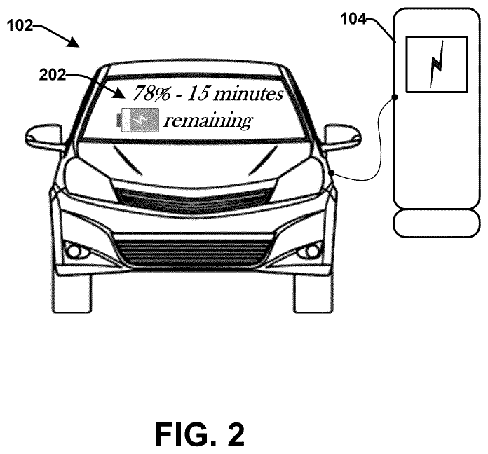

Additionally, or alternatively, the charge display component 132 can control generating visual signals indicating various aspects of the charge status information using the electronic display apparatus 126. For example, in embodiments in which the electronic display apparatus 126 corresponds to a light projection configured to project visual image data onto one or more windows of the vehicle 102, the visual signals can include or correspond to visual image data (e.g., image data, video data, text data, symbol data, pictures, patterns, etc.), as illustrated in FIG. 2.

In this regard, FIG. 2 illustrates an implementation of an example method for externally displaying vehicle charge status information in accordance with one or more embodiments described herein. With reference to FIGS. 1 and 2, in accordance with the example implementation of system 100 illustrated in FIG. 2, vehicle 102 is connected to the external charging apparatus 104 and the battery system 122 is in a state of charging. The charging status information displayed as a visual light projection 202 onto the front windshield of the vehicle (e.g., using a light projector located inside the vehicle 102) and includes both text and symbols. For example, the battery symbol with the lighting icon is used to indicate the battery system 122 is currently in a state of charging and the text shown indicates the current SoC of the vehicle is 78% and 15 minutes remain until the battery system 122 is fully charged.

With these embodiments, information defining different light projections signals corresponding to different types of charge status information can be defined in the charge display protocol data 136. The charge display protocol data 136 can also define and control what types of charge status information light projection signals to display when and the rate displaying updated charge status information in association with connection of the vehicle to the external charging apparatus 104 (e.g., in real-time or in accordance with another defined update rate). The charge display component 132 can further control the lights 124 to generate the corresponding signals in accordance with the charge display protocol data 136. In accordance with any of these techniques for generating visual signals regarding the SoC and/or charging session of the vehicle 102, the visual signals can easily be seen by user of the vehicle positioned outside the vehicle and located a reasonable distance away from the vehicle. Accordingly, the user does not need to get close to the external charging apparatus 104 to see (e.g., as typically displayed via a display device on the external charging apparatus 104) the charging status information.

It should be appreciated that visual light projection 202 is merely exemplary and that various other types of image data, text, and/or symbols can be used. In addition, although displayed on the front windshield, the visual light projection 202 (and/or variations thereof) can be displayed on alternative and/or one or more other windows of the vehicle 102. In other embodiments, the light projection apparatus used can include or correspond to a light projector that projects the visual light projection 202 (and/or variations thereof) onto an area of the ground outside of the vehicle 102. Still additionally, or alternatively, the charge display component 132 can generate visual signals indicative of different types of charge status information (e.g., different charging/discharging states, different levels of charge, different rates of charge, errors, etc.) using different lights of the vehicle (e.g., different external lights of the vehicle), lighting colors, and/or pulsed light patterns or sequences.

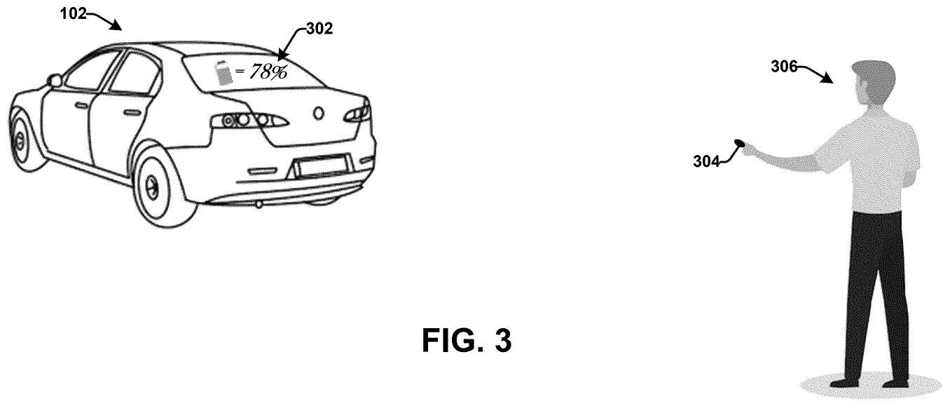

In some embodiments, the charge display component 132 can also facilitate or control displaying visual signals indicating the SoC of the battery system 122 when the vehicle is not connected to an external charging apparatus 104. For example, in some cases, a user of the vehicle may desire to know the current SoC of a vehicle 102 prior to entering the vehicle or otherwise using the vehicle 102. In other words, the user may desire to check the current SoC of the vehicle 102 from a distance and without having to enter the vehicle 102 and turn it on to be presented with the current SoC data via the infotainment system of the vehicle or the like. With these embodiments, the charge display component 132 can be configured to generate or control/direct the lights 124 and/or the electronic display apparatus 126 to generate a visual signal indicative of the current SoC of the battery system 122 in response to a trigger signal. For example, in some implementations, the trigger signal can include or correspond to a radio frequency request signal emitted by a key fob device (e.g., key fob 304) associated with the vehicle 102 in response to pressing of a corresponding button on the key fob device, as illustrated in FIG. 3. Other trigger signals are envisioned, such as detection of proximity of the user a defined distance away from the vehicle 102 or another suitable trigger signal provided by the user and/or another type of external device.

In this regard, FIG. 3 illustrates an implementation of another example method for externally displaying vehicle charge status information in accordance with one or more embodiments described herein. With reference to FIGS. 1-3, in accordance with the example method shown in FIG. 3, the vehicle 102 is displaying a visual light projection 302 on the back windshield indicating the current SoC of the battery system 122 (e.g., using charge display component 132 and electronic display apparatus 126). In accordance with this example, the charge display component 132 is configured to display the SoC of the battery system 122 as a visual light projection 302 in respond to a person 306 located at a position outside the vehicle pressing a corresponding request button on a key fob device 304. For instance, in response to pressing the corresponding request button, the key fob device 304 can transmit (emit, send, etc.) a radio frequency signal that is received by the onboard computer system 106 and which includes or represents information indicating a request to present the SoC visual signal data (e.g., visual light projection 302).

Another scenario in which it would be useful to be able to view the current SoC of a vehicle in accordance with the disclosed techniques includes a scenario in which a user may selectively choose an EV for usage amongst a plurality of EVs (e.g., a car rental scenario or the like). In this scenario, the current SoC of the respective vehicles can significantly influence their vehicle selection, as users typically prefer a vehicle with a high (or highest) SoC. With the disclosed techniques, the respective vehicles can display visual signal data indicating their current SoC using one or more of the visual signaling techniques disclosed herein such that a user can easily and efficiently view the current SoCs of the respective vehicles from a position external to the respective vehicles. In accordance with these embodiments, the charge display component 132 of the respective vehicles can be configured to display (or otherwise control the rendering of) visual signals by the respective vehicles indicating their current SoC in an always on fashion whenever the vehicle is parked, or in accordance with another defined triggering context/event (e.g., based on the vehicle location, time of day, in response to detection of a user walking by or near the vehicle, or the like).

To this end, the manner in which the vehicle 102 generates visual signals indicating information regarding the SoC of and/or charging status of the vehicle in association with connection to an external charging apparats 104 or otherwise can vary. In addition, the particular manner in which different visual signals are defined to correspond to different information related to the vehicle battery system 122 can also vary. As noted above, the charge display protocol data 136 can define and control how and when the vehicle uses different visual signals to externally display different types of information regarding the vehicle batter system 122 SoC and charging status. In some embodiments, the programming component 134 can enable a user of the vehicle to program/define the charge display protocol data 136 as tailored based on the user's preferences. For example, the programming component 134 can allow the user to define and/or tailor the charge display protocol data 136 using the infotainment system of the vehicle 102 and/or an external device coupled to the vehicle onboard computer system 102 and an associated vehicle charge display control application deployed on the external device.

The onboard computer system 106 can also include a human-machine interface 108 that provides for receiving user input in association with programming the charge display protocol data 136 and presenting information to users. For example, the human-machine interfaces 108 can include or correspond to any suitable output device such as a display, a speaker, etc. and any suitable input device, such as a touchscreen display, a microphone, a keypad, a keyboard, and the like. Examples of suitable input and output devices of the human-machine interface 108 devices are further provided with reference to FIG. 7.

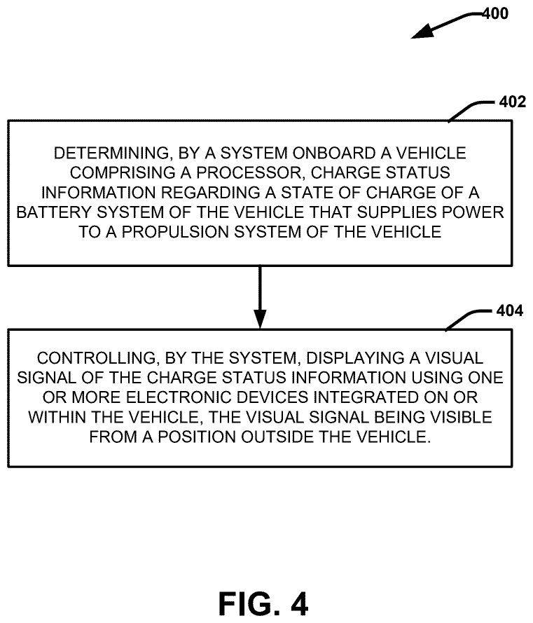

FIG. 4 illustrates a block flow diagram of an example, non-limiting computer-implemented method 400 for externally displaying vehicle charge status information in accordance with one or more embodiments described herein. Method 400 comprises, at 402, determining (e.g., via charge status component 130), by a system onboard a vehicle (e.g., vehicle 102) comprising a processor (e.g., onboard computer system 106), charge status information regarding a SoC of a battery system (e.g., battery system 122) of the vehicle that supplies power to a propulsion system of the vehicle. At 404, method 400 comprises controlling, by the system (e.g. via charge display component 132), displaying a visual signal of the charge status information using one or more electronic devices integrated on or within the vehicle, the visual signal being visible from a position outside the vehicle.

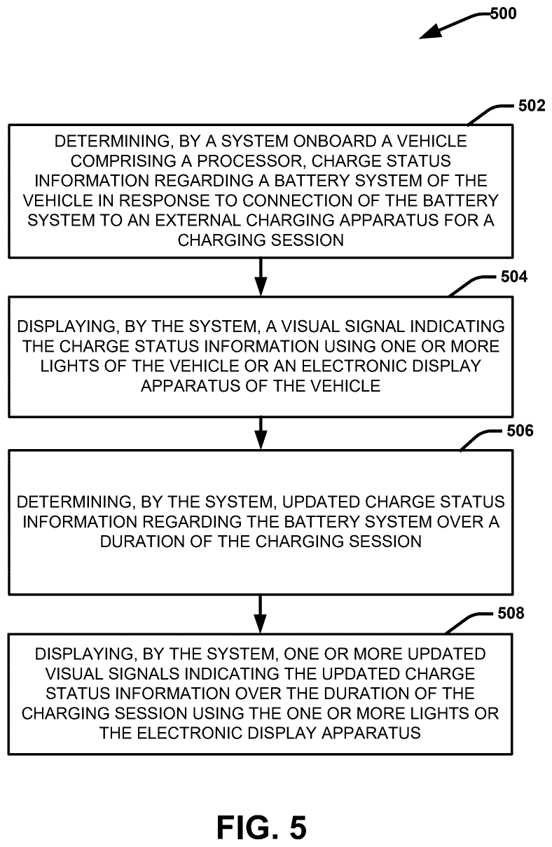

FIG. 5 illustrates a block flow diagram of another example, non-limiting computer-implemented method 500 for externally displaying vehicle charge status information in accordance with one or more embodiments described herein. Method 500 comprises, at 502, determining (e.g., via charge status component 130), by a system onboard a vehicle (e.g., vehicle 102) comprising a processor (e.g., onboard computer system 106), charge status information regarding a battery system (e.g., battery system 122) of the vehicle in response to connection of the battery system to an external charging apparatus for a charging session. At 504, method 500 comprises displaying, by the system (e.g. via charge display component 132), a visual signal indicating the charge status information using one or more lights of the vehicle or an electronic display apparatus of the vehicle. At 506, method 500 comprises determining, by the system (e.g., via charge status component 130), updated charge status information regarding the battery system over a duration of the charging session. At 508, method 500 comprises displaying, by the system (e.g. via charge display component 132), one or more updated visual signals indicating the updated charge status information over the duration of the charging session using the one or more lights or the electronic display apparatus 126.

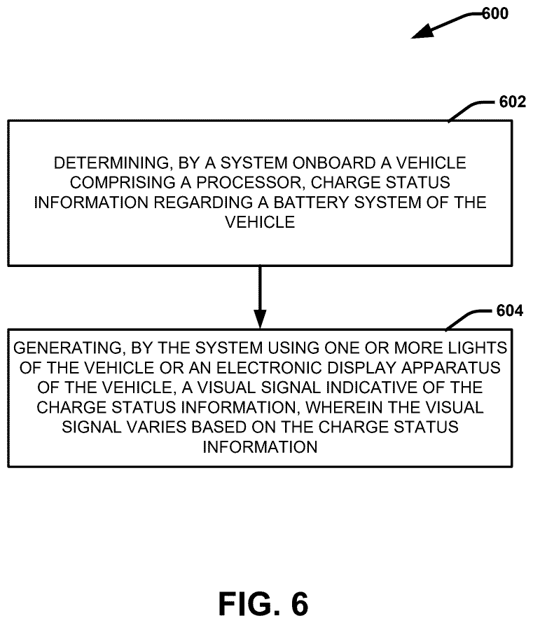

FIG. 6 illustrates a block flow diagram of another example, non-limiting computer-implemented method 600 for externally displaying vehicle charge status information in accordance with one or more embodiments described herein. Method 600 comprise, at 602, determining (e.g., via charge status component 130), by a system onboard a vehicle (e.g., vehicle 102) comprising a processor (e.g., onboard computer system 106), charge status information regarding a battery system (e.g., battery system 122) of the vehicle 102. For example, the charge status information can comprise at least one of, a current SoC of the battery system, a current operating state of the battery system (e.g., charging, discharging, not charging or discharging), a remaining duration of time until the battery system reaches a maximum charge capacity, and a current charging rate, and/or fault information regarding an error or fault of a charging operation in association with connection of the battery system 122 to an external charging apparatus. At 604, method 600 comprises generating, by the system using one or more lights of the vehicle or an electronic display apparatus of the vehicle (e.g. via charge display component 132), a visual signal indicative of the charge status information, wherein the visual signal varies based on the charge status information. For example, the visual signal can vary for different levels of charge, for different charging operations, for different remaining durations of time, for different charging rates, for different charging fault conditions, and so on.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

In order to provide additional context for various embodiments described herein, FIG. 7 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors, field-programmable gate array, AI accelerator application-specific integrated circuit, or other suitable processors. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data. It is noted that unified Extensible Firmware Interface(s) can be utilized herein.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a disc 722 such as a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1374 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the. NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can be enabled with a security module, such as a trusted processing module (TPM). For instance, with a TPM, boot components hash next in time boot components, and wait for a match of results to secured values, before loading a next boot component. This process can take place at any layer in the code execution stack of computer 702, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1374 serial port, a game port, a USB port, an IR interface, a BLUETOOTH® interface, etc.

A monitor 746 or other type of display device can be also connected to the system bus 708 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the Internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

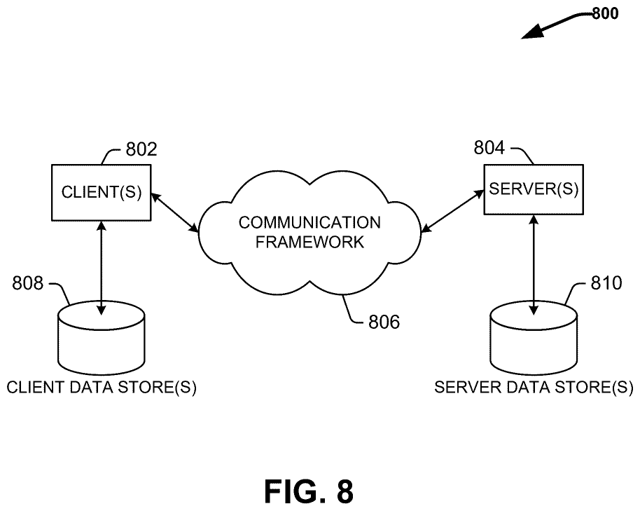

Referring now to FIG. 8, there is illustrated a schematic block diagram of a computing environment 800 in accordance with this specification. The system 800 includes one or more client(s) 802, (e.g., computers, smart phones, tablets, cameras, PDA's). The client(s) 802 can be hardware and/or software (e.g., threads, processes, computing devices). The client(s) 802 can house cookie(s) and/or associated contextual information by employing the specification, for example.

The system 800 also includes one or more server(s) 804. The server(s) 804 can also be hardware or hardware in combination with software (e.g., threads, processes, computing devices). The servers 804 can house threads to perform transformations of media items by employing aspects of this disclosure, for example. One possible communication between a client 802 and a server 804 can be in the form of a data packet adapted to be transmitted between two or more computer processes wherein data packets may include coded analyzed headspaces and/or input. The data packet can include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804. Further, the client(s) 802 can be operatively connected to one or more server data store(s) 810.

In one exemplary implementation, a client 802 can transfer an encoded file, (e.g., encoded media item), to server 804. Server 804 can store the file, decode the file, or transmit the file to another client 802. It is noted that a client 802 can also transfer uncompressed file to a server 804 and server 804 can compress the file and/or transform the file in accordance with this disclosure. Likewise, server 804 can encode information and transmit the information via communication framework 806 to one or more clients 802.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group”as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A vehicle, comprising:
a memory that stores computer executable components; and
a processor that executes the computer executable components stored in the memory, wherein the computer executable components comprise:
   a charge status component that determines charge status information regarding a state of charge of a battery system of the vehicle that supplies power to a propulsion system of the vehicle; and
   a charge display component that controls displaying a visual signal of the charge status information using one or more electronic devices integrated on or within the vehicle, the visual signal being visible from a position outside the vehicle.2. The vehicle of clause 1, wherein the charge display component generates the visual signal using an electronic display apparatus of the vehicle that projects the visual signal onto one or more windows of the vehicle.

3. The vehicle of clause 1, wherein the charge display component generates the visual signal using an electronic display apparatus of the vehicle that projects the visual signal onto an area of ground external to the vehicle.

4. The vehicle of clause 1, wherein the charge display component generates the visual signal using one or more lights of the vehicle.

5. The vehicle of clause 4, wherein the one or more lights comprise at least one exterior light of the vehicle.

6. The vehicle of clause 4, wherein the visual signal comprises a pulsed light projection pattern.

7. The vehicle of clause 4, wherein the visual signal employs different light colors to indicate different aspects of the charge status information.

8. The vehicle of clause 1, wherein the charge status component determines the charge status information in association with connection of the battery system to an external charging apparatus.

9. The vehicle of clause 8, wherein the charge status information indicates whether the battery system is in a state of charging or a state of discharging.

10. The vehicle of clause 8, wherein the charge status information indicates a current state of charge of the battery system.

11. The vehicle of clause 8, wherein the charge status information indicates an amount of time remaining until the state of charge reaches a maximum state of charge.

The system of clause 1 above with any set of combinations of the vehicles of clauses 2-11 above.

12. A method, comprising:
determining, by a system onboard a vehicle comprising a processor, charge status information regarding a state of charge of a battery system of the vehicle that supplies power to a propulsion system of the vehicle; and
controlling, by the system, displaying a visual signal of the charge status information using one or more electronic devices integrated on or within the vehicle, the visual signal being visible from a position outside the vehicle.16. The method of clause 15, wherein the biometric data comprises facial image data of the person and wherein the identification/verification process comprises a facial recognition process.

13. The method of clause 12, wherein the controlling comprises generating, by the system, the visual signal using an electronic display apparatus of the vehicle that projects the visual signal onto one or more windows of the vehicle.

14. The method of clause 12, wherein the controlling comprises generating, by the system, the visual signal using an electronic display apparatus of the vehicle that projects the visual signal onto an area of ground external to the vehicle.

15. The method of clause 12, wherein the controlling comprises generating, by the system, the visual signal using one or more lights of the vehicle.

16. The method of clause 15, wherein the one or more lights comprise at least one exterior light of the vehicle.

17. The method of clause 15, wherein the visual signal employs different light colors or different pulsed light projection patterns to indicate different aspects of the charge status information.

18. The method of clause 12, wherein the determining comprises determining the charge status information in association with connection of the battery system to an external charging apparatus.

The method of clause 12 above with any set of combinations of the methods of clauses 13-18 above.

A non-transitory machine-readable storage medium, comprising executable instructions that, when executed by a processor onboard a vehicle, facilitate performance of operations, comprising:
determining charge status information regarding a state of charge of a battery system of the vehicle that supplies power to a propulsion system of the vehicle; and
controlling displaying a visual signal of the charge status information using one or more electronic devices integrated on or within the vehicle, the visual signal being visible from a position outside the vehicle.

20. The non-transitory machine-readable storage medium of clause 19, wherein the controlling comprises as least one of:
generating the visual signal using an electronic display apparatus of the vehicle, or
generating the visual signal using one or more lights of the vehicle.

What is claimed is:

1. A vehicle, comprising:
a memory that stores computer executable components; and
a processor that executes the computer executable components stored in the memory, wherein the computer executable components comprise:
a charge status component that determines charge status information regarding a state of charge of a battery system of the vehicle that supplies power to a propulsion system of the vehicle; and
a charge display component that controls displaying a visual signal of the charge status information using one or more electronic devices integrated on or within the vehicle, the visual signal being visible from a position outside the vehicle.

2. The vehicle of claim 1, wherein the charge display component generates the visual signal using an electronic display apparatus of the vehicle that projects the visual signal onto one or more windows of the vehicle.

3. The vehicle of claim 1, wherein the charge display component generates the visual signal using an electronic display apparatus of the vehicle that projects the visual signal onto an area of ground external to the vehicle.

4. The vehicle of claim 1, wherein the charge display component generates the visual signal using one or more lights of the vehicle.

5. The vehicle of claim 4, wherein the one or more lights comprise at least one exterior light of the vehicle.

6. The vehicle of claim 4, wherein the visual signal comprises a pulsed light projection pattern.

7. The vehicle of claim 4, wherein the visual signal employs different light colors to indicate different aspects of the charge status information.

8. The vehicle of claim 1, wherein the charge status component determines the charge status information in association with connection of the battery system to an external charging apparatus.

9. The vehicle of claim 8, wherein the charge status information indicates whether the battery system is in a state of charging or a state of discharging.

10. The vehicle of claim 8, wherein the charge status information indicates a current state of charge of the battery system.

11. The vehicle of claim 8, wherein the charge status information indicates an amount of time remaining until the state of charge reaches a maximum state of charge.

12. A method, comprising:
determining, by a system onboard a vehicle comprising a processor, charge status information regarding a state of charge of a battery system of the vehicle that supplies power to a propulsion system of the vehicle; and
controlling, by the system, displaying a visual signal of the charge status information using one or more electronic devices integrated on or within the vehicle, the visual signal being visible from a position outside the vehicle.

13. The method of claim 12, wherein the controlling comprises generating, by the system, the visual signal using an electronic display apparatus of the vehicle that projects the visual signal onto one or more windows of the vehicle.

14. The method of claim 12, wherein the controlling comprises generating, by the system, the visual signal using an electronic display apparatus of the vehicle that projects the visual signal onto an area of ground external to the vehicle.

15. The method of claim 12, wherein the controlling comprises generating, by the system, the visual signal using one or more lights of the vehicle.

16. The method of claim 15, wherein the one or more lights comprise at least one exterior light of the vehicle.

17. The method of claim 15, wherein the visual signal employs different light colors or different pulsed light projection patterns to indicate different aspects of the charge status information.

18. The method of claim 12, wherein the determining comprises determining the charge status information in association with connection of the battery system to an external charging apparatus.

19. A non-transitory machine-readable storage medium, comprising executable instructions that, when executed by a processor onboard a vehicle, facilitate performance of operations, comprising:
determining charge status information regarding a state of charge of a battery system of the vehicle that supplies power to a propulsion system of the vehicle, and
controlling displaying a visual signal of the charge status information using one or more electronic devices integrated on or within the vehicle, the visual signal being visible from a position outside the vehicle.

20. The non-transitory machine-readable storage medium of claim 19, wherein the controlling comprises as least one of:
generating the visual signal using an electronic display apparatus of the vehicle, or
generating the visual signal using one or more lights of the vehicle.
